(19) United States
(12) Patent Application Publication
(10) Pub. No.: US 2015/0203615 A1
(43) Pub. Date: Jul. 23, 2015

(54) ALKALI METAL-ZINC IONOMER COMPOSITIONS

(71) Applicant: E I DU PONT DE NEMOURS AND COMPANY, Wilimington, DE (US)

(72) Inventor: Richard Allen Hayes, Beaumont, TX (US)

(73) Assignee: E I DU PONT DE NEMOURS AND COMPANY, Wilmington, DE (US)

(21) Appl. No.: 14/161,148

(22) Filed: Jan. 22, 2014

(51) Int. Cl. C08F 210/02; D21H 19/20; D06M 15/227; C09D 123/26; D06M 15/263

(52) U.S. Cl. CPC C08F 210/02; C09D 123/26; D06M 15/263; D06M 15/227; D21H 19/20

(57) ABSTRACT

Disclosed are ionomer compositions comprising ionomers neutralized with a combination of alkali metal cations and zinc cations, methods to form aqueous dispersions comprising the ionomers and methods to form coatings comprising the ionomers on substrates.

### FIELD OF THE INVENTION

The present invention is directed to certain ionomer compositions, methods to form aqueous dispersions and methods to form coatings comprising ionomers on a substrate.

### BACKGROUND OF THE INVENTION

Ionomers of ethylene copolymers with alpha,beta-ethylenically unsaturated carboxylic acids are known in the art, wherein at least a portion of the carboxylic acid groups of the copolymer are neutralized to form carboxylate salts comprising alkali metal, alkaline earth metal or transition metal cations. See for example U.S. Pat. Nos. 3,264,272; 3,338,739; 3,355,319; 5,155,157; 5,244,969; 5,304,608; 5,542,677; 5,591,803; 5,688,869; 6,100,336; 6,245,858; 6,518,365; and U.S. Patent Application Publication 2009/0297747.

Aqueous dispersions of ionomers are also known in the art. See for example U.S. Pat. Nos. 3,896,065; 3,904,569; 4,136,069; 4,508,804; 5,409,765; and Japanese Patent Applications JP01009338 and JP05075769. They have been produced by dissolving the acid copolymer precursors in a solvent, neutralization of the acid functionalities with generally ammonia, amines or alkali metal ions, and dilution of the solution into water followed by partial or complete removal of the solvent. See for example U.S. Pat. Nos. 2,313,144; 3,296,172; 3,389,109; 3,562,196; 5,430,111; 5,591,806; British Patent GB1243303; Japanese Patent Applications JP50084687 and JP2009091426.

Aqueous ionomer dispersions have also been produced by heating acid copolymer precursors or ionomers in hot aqueous ammonia and other neutralizing agents. See for example U.S. Pat. Nos. 3,644,258; 3,674,896; 3,823,108; 3,970,626; 4,540,736; 5,330,788; 5,550,177; U.S. Patent Application Publication 2007/0117916; Japanese Patent Application JP06000872; and PCT Patent Application Publication WO2000/044801.

Aqueous ionomer dispersions have also been produced by dispersing the acid copolymer precursor in aqueous solutions of neutralizing agents at temperatures under high shear process conditions above the boiling point of water, necessitating the use of pressure vessels such as autoclaves and extruders. See for example U.S. Pat. Nos. 4,775,713; 4,970,258; 4,978,707; 5,374,687; 5,445,893; 7,279,513; 7,528,080; U.S. Patent Application Publications 2005/0100754; 2006/0124554; 2007/0141323; 2007/0144697; 2007/0292705; 2007/0295464; 2007/0295465; 2008/0000598; 2008/0000602; 2008/0041543; 2008/0073045; 2008/0073046; 2008/0118728; 2008/0135195; 2008/0176968; 2008/0182040; 2008/0216977; 2008/0230195; 2008/0292833; 2008/0295985; 2009/0194450; 2009/0253321; European Patent Application EP1163276; PCT Patent Application WO 2011/058119; WO 2011/058121; WO 2011/068525; and Japanese Patent Applications JP2958120; JP10006640; and JP50135141.

Aqueous ionomer dispersions have also been produced by dispersing the ionomer in aqueous solutions under high shear process conditions at temperatures above the boiling point of water, necessitating the use of pressure vessels such as autoclaves and extruders. See for example U.S. Pat. Nos. 4,173,669; 4,329,305; 4,410,655; 4,440,908; 6,458,897; Japanese Applications JP11158332; JP2000328046; JP2005075878; and PCT Patent Application Publication WO1999/10276.

Aqueous ionomer dispersions have also been produced by dispersing highly neutralized, low melt index (MI) ionomers in hot water. See for example U.S. Pat. Nos. 3,321,819; 3,472,825; and 4,181,566. See also U.S. Patent Application Publications 2013/0059972, 2013/0149930 2013/0116373, 2013/0224506, 2013/0224505, 2013/0225021 2013/0225749 and 2013/0225750 and PCT Patent Application Publication WO2013/086950.

Ammonia-neutralized ionomer aqueous dispersions have been used to coat certain substrates. See for example U.S. Pat. Nos. 3,872,039; 3,899,389; 3,983,268; 4,340,659; 4,400,440; 4,714,728; 5,336,528; and 6,852,792. As is well known in the art, ammonia-neutralized ionomers liberate the ammonia upon drying to reform the parent acid copolymer and are not redispersible in hot water.

Low molecular weight ionomer waxes have been used as temporary coatings removable with hot water. See for example U.S. Pat. No. 5,292,794.

Certain ionomer articles have been dispersed in aqueous caustic solutions. See for example U.S. Pat. No. 6,162,852.

Certain ionomer dispersions have been used as primer coatings for substrates, such as PET, biaxially oriented polypropylene (BOPP) and aluminum foil films. See for example U.S. Pat. Nos. 5,419,960; 6,013,353; 7,364,800; 7,470,736; and U.S. Patent Application Publication 2005/0271888.

Highly neutralized ionomer dispersions have been used as fabric or paper treatments. See for example U.S. Pat. Nos. 5,082,697; 5,206,279; and 5,387,635.

Ionomer dispersions, produced through autoclave or extrusion processes, have been used as internal and external paper sizing or paper additives. See for example U.S. Pat. Nos. 5,993,604; 6,482,886; 7,588,662; U.S. Patent Application Publications 2007/0137808; 2007/0137809; 2007/0137810; 2007/0137811; 2007/0137813; 2007/0141936; 2007/0243331; and 2007/0284069.

Certain ionomer dispersions have been used in repulpable paper compositions. See for example U.S. Pat. No. 5,160,484.

U.S. Pat. No. 6,680,082 describes mixed ion ionomers, particularly ionomers with a mixture of zinc and magnesium, calcium, sodium or lithium for metal coating powder applications. U.S. Pat. No. 5,741,370 describes a mixture of sodium ionomer and zinc ionomer useful as a material for a solar module backskin. U.S. Patent Application Publication 2008/0097047 discloses blends of polyamides with ionomers, including blends with mixtures of zinc and sodium ionomers.

### SUMMARY OF THE INVENTION

The invention provides an ionomer composition comprising or consisting essentially of a parent acid copolymer that consists of copolymerized units of ethylene and 18 to 30 weight % of copolymerized units of acrylic acid or methacrylic acid, based on the total weight of the parent acid copolymer, the parent acid copolymer having a melt flow rate (MFR) from 200 to 1000 g/10 min., wherein 50% to 70% of the carboxylic acid groups of the copolymer, based on the total carboxylic acid content of the parent acid copolymer as calculated for the non-neutralized parent acid copolymer, are neutralized to carboxylic acid salts consisting of 90 to 99%, based on the total of neutralized carboxylic acid salts, monovalent alkali metal cations selected from the group consisting of sodium cations, potassium cations, lithium cations or mixtures thereof and 10 to 1%, based on the total of neutralized carboxylic acid salts, of zinc cations and wherein the ionomer composition has a MFR from 1 to 20 g/10 min., each MFR measured according to ASTM D1238 at 190° C. with a 2160 g load.

Preferably, the ionomer compositions are neutralized to carboxylic acid salts consisting of 91.5 to 99%, based on the total of neutralized carboxylic acid salts, of sodium cations, potassium cations, lithium cations or mixtures thereof and 8.5 to 1%, based on the total of neutralized carboxylic acid salts, of zinc cations.

The invention also provides a method to form an aqueous dispersion comprising water and comprising or consisting essentially of (a) providing an ionomer composition comprising or consisting essentially of a parent acid copolymer that consists of copolymerized units of ethylene and 18 to 30 weight % of copolymerized units of acrylic acid or methacrylic acid, based on the total weight of the parent acid copolymer, the parent acid copolymer having a melt flow rate (MFR) from 200 to 1000 g/10 min., wherein 50% to 70% of the carboxylic acid groups of the copolymer, based on the total carboxylic acid content of the parent acid copolymer as calculated for the non-neutralized parent acid copolymer, are neutralized to carboxylic acid salts consisting of 90 to 99%, based on the total of neutralized carboxylic acid salts, monovalent alkali metal cations selected from the group consisting of sodium cations, potassium cations, lithium cations or mixtures thereof and 10 to 1%, based on the total of neutralized carboxylic acid salts, of zinc cations and wherein the ionomer composition has a MFR from 1 to 20 g/10 min., each MFR measured according to ASTM D1238 at 190° C. with a 2160 g load;

(a) mixing the solid ionomer composition with water at a temperature from 85 to 100° C. to provide a heated aqueous ionomer dispersion wherein the ionomer composition comprises 0.001 to 50 weight % of the aqueous ionomer dispersion;

(c) optionally cooling the heated aqueous ionomer dispersion to a temperature of 20 to 30° C., wherein the ionomer remains dispersed in the liquid phase.

One embodiment of this method is wherein (b) comprises (i) adding an article formed from the preformed solid ionomer composition to water at a temperature of 20 to 30° C. to form a mixture of solid ionomer and water; and subsequently (ii) heating the mixture to a temperature from 85 to 100° C. Another embodiment is wherein (b) comprises adding an article formed from the preformed solid ionomer composition to water preheated to a temperature from 85 to 100° C.

The invention further provides a coated substrate comprising or consisting essentially of an ionomer layer on a substrate wherein

(a) the substrate comprises paper, paperboard, cardboard, pulp-molded shape, textile, material made from a synthetic fiber spun fabric, film, open-cell foam, closed-cell foam, or metallic foil; and

(b) the ionomer layer comprises an ionomer composition comprising a parent acid copolymer that consists of copolymerized units of ethylene and 18 to 30 weight % of copolymerized units of acrylic acid or methacrylic acid, based on the total weight of the parent acid copolymer, the parent acid copolymer having a melt flow rate (MFR) from 200 to 1000 g/10 min., wherein 50% to 70% of the carboxylic acid groups of the copolymer, based on the total carboxylic acid content of the parent acid copolymer as calculated for the non-neutralized parent acid copolymer, are neutralized to carboxylic acid salts consisting of 90 to 99%, based on the total of neutralized carboxylic acid salts, monovalent alkali metal cations selected from the group consisting of sodium cations, potassium cations, lithium cations or mixtures thereof and 10 to 1%, based on the total of neutralized carboxylic acid salts, of zinc cations and wherein the ionomer composition has a MFR from 1 to 20 g/10 min., each MFR measured according to ASTM D1238 at 190° C. with a 2160 g load.

The invention also provides a method to form a coating comprising an ionomer on a substrate; comprising (a) providing an ionomer composition comprising or consisting essentially of the ionomer composition described above; (b) providing a substrate; and (c) applying the ionomer composition to the substrate.

One embodiment comprises the method wherein the ionomer composition is in the form of an aqueous ionomer dispersion wherein the aqueous ionomer dispersion is prepared by

(1) providing a solid ionomer composition comprising a parent acid copolymer that consists of copolymerized units of ethylene and 18 to 30 weight % of copolymerized units of acrylic acid or methacrylic acid, based on the total weight of the parent acid copolymer, the parent acid copolymer having a melt flow rate (MFR) from 200 to 1000 g/10 min., wherein 50% to 70% of the carboxylic acid groups of the copolymer, based on the total carboxylic acid content of the parent acid copolymer as calculated for the non-neutralized parent acid copolymer, are neutralized to carboxylic acid salts consisting of 90 to 99%, based on the total of neutralized carboxylic acid salts, monovalent alkali metal cations selected from the group consisting of sodium cations, potassium cations, lithium cations or mixtures thereof and 10 to 1%, based on the total of neutralized carboxylic acid salts, of zinc cations and wherein the ionomer composition has a MFR from 1 to 20 g/10 min., each MFR measured according to ASTM D1238 at 190° C. with a 2160 g load;

(2) mixing the solid ionomer composition with water at a temperature from 85 to 100° C. to provide a heated aqueous ionomer dispersion wherein the ionomer composition comprises 0.001 to 50 weight % of the aqueous ionomer dispersion;

(3) optionally cooling the heated aqueous ionomer dispersion to a temperature of 20 to 30° C., wherein the ionomer remains dispersed in the liquid phase; and wherein

(c) comprises (1) coating the aqueous ionomer dispersion onto the substrate; and

(2) drying the coated substrate at a temperature of 20 to 150° C.

One embodiment of this method is wherein (a)(2) comprises (i) adding an article formed from the preformed solid ionomer composition to water at a temperature of 20 to 30° C. to form a mixture of solid ionomer and water; and subsequently (ii) heating the mixture to a temperature from 85 to 100° C. Another embodiment is wherein (a)(2) comprises adding an article formed from the preformed solid ionomer composition to water preheated to a temperature from 85 to 100° C.

Another method to prepare the coated substrate comprises or consists essentially of an embodiment comprising

(a) providing a solid ionomer composition comprising a parent acid copolymer that consists of copolymerized units of ethylene and 18 to 30 weight % of copolymerized units of acrylic acid or methacrylic acid, based on the total weight of the parent acid copolymer, the parent acid copolymer having a melt flow rate (MFR) from 200 to 1000 g/10 min., wherein 50% to 70% of the carboxylic acid groups of the copolymer, based on the total carboxylic acid content of the parent acid copolymer as calculated for the non-neutralized parent acid copolymer, are neutralized to carboxylic acid salts consisting of 90 to 99%, based on the total of neutralized carboxylic acid salts, monovalent alkali metal cations selected from the group consisting of sodium cations, potassium cations, lithium cations or mixtures thereof and 10 to 1%, based on the total of neutralized carboxylic acid salts, of zinc cations and wherein the ionomer composition has a MFR from 1 to 20 g/10 min., each MFR measured according to ASTM D1238 at 190° C. with a 2160 g load;

(b) providing the substrate;

(c)(1) melting the solid ionomer composition at a temperature from 80 to 300° C. to provide a molten, flowable ionomer composition;

(2) coating the molten ionomer composition onto the substrate; and

(3) cooling the coated substrate to a temperature of 20 to 30° C.

Another method to prepare the coated substrate comprises or consists essentially of

(a) providing a preformed film of an ionomer composition comprising a parent acid copolymer that consists of copolymerized units of ethylene and 18 to 30 weight % of copolymerized units of acrylic acid or methacrylic acid, based on the total weight of the parent acid copolymer, the parent acid copolymer having a melt flow rate (MFR) from 200 to 1000 g/10 min., wherein 50% to 70% of the carboxylic acid groups of the copolymer, based on the total carboxylic acid content of the parent acid copolymer as calculated for the non-neutralized parent acid copolymer, are neutralized to carboxylic acid salts consisting of 90 to 99%, based on the total of neutralized carboxylic acid salts, monovalent alkali metal cations selected from the group consisting of sodium cations, potassium cations, lithium cations or mixtures thereof and 10 to 1%, based on the total of neutralized carboxylic acid salts, of zinc cations and wherein the ionomer composition has a MFR from 1 to 20 g/10 min., each MFR measured according to ASTM D1238 at 190° C. with a 2160 g load;

(b) providing a substrate;

(c)(1) producing a prelaminate structure comprising a layer of the ionomer film layer adjacent to the substrate;

(2) laminating the ionomer film layer to the substrate layer at a temperature from 50 to 150° C. and optionally with applied pressure;

(3) cooling the coated substrate to a temperature of 20 to 30° C.

### DETAILED DESCRIPTION OF THE INVENTION

Unless otherwise defined, all technical and scientific terms used herein have the same meaning as commonly understood by one of ordinary skill in the art to which this invention belongs. In case of conflict, the specification, including definitions, will control.

Although methods and materials similar or equivalent to those described herein can be used in the practice or testing of the invention, suitable methods and materials are described herein.

Unless stated otherwise, all percentages, parts, ratios, etc., are by weight. When an amount, concentration, or other value or parameter is given as either a range, preferred range or a list of lower preferable values and upper preferable values, this is to be understood as specifically disclosing all ranges formed from any pair of any lower range limit or preferred value and any upper range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

The transitional phrase “consisting essentially of” limits the scope of a claim to the specified materials or steps and those that do not materially affect the basic and novel characteristic(s) of the claimed invention. Where applicants have defined an invention or a portion thereof with an open-ended term such as “comprising,” unless otherwise stated the description should be interpreted to also describe such an invention using the term “consisting essentially of”.

Use of “a” or “an” are employed to describe elements and components of the invention. This is merely for convenience and to give a general sense of the invention. This description should be read to include one or at least one and the singular also includes the plural unless it is obvious that it is meant otherwise.

In describing certain polymers it should be understood that sometimes applicants are referring to the polymers by the monomers used to produce them or the amounts of the monomers used to produce the polymers. While such a description may not include the specific nomenclature used to describe the final polymer or may not contain product-by-process terminology, any such reference to monomers and amounts should be interpreted to mean that the polymer comprises copolymerized units of those monomers or that amount of the monomers, and the corresponding polymers and compositions thereof.

The term “copolymer” is used to refer to polymers formed by copolymerization of two or more monomers. Such copolymers include dipolymers consisting essentially of two copolymerized comonomers.

As used herein, “disperse,” “dispersing” and related terms refer to a process in which solid articles such as pellets of polymer are mixed with water and over a brief period of time disappear into the liquid phase. The terms “aqueous dispersion” and “dispersion” describe a free-flowing liquid with no solids visible to the human eye. No characterization is made regarding the interaction of the polymer molecules with the water molecules in such aqueous dispersions. “Self-dispersible” means that the material disperses readily in hot (85 to 100° C.) water without need for additional dispersants or reagents.

Methods to produce aqueous dispersions comprising ionomers are disclosed herein. Surprisingly, we have found that ionomers with certain compositional characteristics readily form aqueous dispersions when mixed with hot water under low shear conditions. In contrast, previous methods required significantly more rigorous conditions to form dispersions.

A shortcoming of the art is that hot water self-dispersible ionomers have been limited to monovalent cation neutralization. Ionomers neutralized with multivalent cations, such as divalent and trivalent cations, have not been found to be hot water self-dispersible due to the multivalent cation's tendency to form polymeric crosslinks. Ionomers neutralized with multivalent cations may provide the benefit of improved melt rheology for certain melt processes, such as blown film and extrusion coatings, and reduced moisture absorption in the enduse article. The present invention overcomes these prior art shortcomings and provides certain mixed monovalent cation:zinc-neutralized ionomers that maintain the desirable hot water self-dispersible attributes. In particular, compositions comprising ionomers containing a combination of alkali metal and zinc cations readily form aqueous dispersions whereas ionomers comprising only zinc cations do not.

The dispersion formation and coating methods provide a process simplification that requires less energy than disclosed in the prior art dispersion methods, such as high pressure, high shear, autoclave processes or extrusion processes, and provides an inherently safer process, avoiding the handling and use of strong bases.

The ionomer coating on the substrate as disclosed herein can be in the form of a monolithic membrane that functions as a barrier to penetration of fluids into or through the substrate. Monolithic membranes have high water-entry pressure and are waterproof and liquidproof. The ionomer coating also allows for providing a heat-sealable surface on a substrate that is not heat-sealable.

Printing properties may be improved by altering the surface of the paper to make it more hydrophobic by the ionomer coating.

Articles comprising the coated substrate provide easily recyclable articles of commerce, for example, through repulping of the coated paper, paperboard and the like.

### Ionomer Composition

The ionomer used herein is derived from certain parent acid copolymers consisting of copolymerized units of ethylene and about 18 to about 30 weight of copolymerized units of an alpha, beta-ethylenically unsaturated carboxylic acid such as acrylic acid or methacrylic acid. Preferably, the parent acid copolymer used herein consists of ethylene and about 19 to about 25 weight %, or more preferably about 19 to about 23 weight %, of the alpha, beta-ethylenically unsaturated carboxylic acid, based on the total weight of the copolymer.

Preferably, the alpha, beta-ethylenically unsaturated carboxylic acid is methacrylic acid. The acid copolymers consist of copolymerized units of ethylene and copolymerized units of the alpha, beta-ethylenically unsaturated carboxylic acid and 0 weight % of additional comonomers; that is, dipolymers of ethylene and the alpha, beta-ethylenically unsaturated carboxylic acid. Preferred acid copolymers are ethylene methacrylic acid dipolymers.

The parent acid copolymers used herein may be polymerized as disclosed in U.S. Pat. Nos. 3,404,134; 5,028,674; 6,500,888; and 6,518,365.

The parent acid copolymers used herein preferably have a melt flow rate (MFR) of about 200 to about 1000 grams/10 min as measured by ASTM D1238 at 190° C. using a 2160 g load. A similar ISO test is ISO 1133. Alternatively, the parent acid copolymers have MFR from a lower limit of 200, 250 or 300 grams/10 min to an upper limit of 400, 500, 600 or 1000 grams/10 min, such as from 250 to 400 grams/10 min. The preferred melt flow rate of the parent acid copolymer provides ionomers with optimum physical properties in the final shaped article while still allowing for rapid self-dispersion in hot water. Ionomers derived from parent acid copolymers with melt flow rates below about 200 grams/10 minutes have minimal hot water self-dispersibility, while ionomers derived from parent acid copolymer melt flow rates of greater than about 1000 grams/10 minutes may reduce the physical properties in the intended enduse.

In some embodiments, blends of two or more ethylene acid copolymers may be used, provided that the aggregate components and properties of the blend fall within the limits described above for the ethylene acid copolymers. For example, two ethylene methacrylic acid dipolymers may be used such that the total weight % of methacrylic acid is about 18 to about 30 weight % of the total polymeric material and the melt flow rate of the blend is about 200 to about 1000 grams/10 min.

The ionomers disclosed herein are produced from the parent acid copolymers, wherein from about 50 to about 70%, or preferably from about 55 to about 60%, such as about 60%, of the total carboxylic acid groups of the parent acid copolymers, as calculated for the non-neutralized parent acid copolymers, are neutralized to carboxylic acid salts consisting of 90 to 99%, based on the total of neutralized carboxylic acid salts, monovalent alkali metal cations selected from the group consisting of sodium cations, potassium cations, lithium cations or mixtures thereof, preferably selected from the group consisting of sodium cations, potassium cations and mixtures thereof, and more preferably sodium cations, and 10 to 1%, based on the total of neutralized carboxylic acid salts, of zinc cations and wherein the ionomer composition has a MFR from 1 to 20 g/10 min., each MFR measured according to ASTM D1238 at 190° C. with a 2160 g load.

Preferably, the ionomer compositions are neutralized to carboxylic acid salts consisting of 91.5 to 99%, based on the total of neutralized carboxylic acid salts, of sodium cations, potassium cations, lithium cations or mixtures thereof, preferably sodium cations, potassium cations and mixtures thereof, and more preferably sodium cations, and 8.5 to 1%, based on the total of neutralized carboxylic acid salts, of zinc cations. The parent acid copolymers may be neutralized using methods disclosed in, for example, U.S. Pat. No. 3,404,134.

Surprisingly, the ionomer compositions of this invention incorporate significant levels of neutralization with the divalent cation zinc while maintaining the desirable hot water self-dispersible attribute. Ionomers neutralized with multivalent cations may provide the benefit of improved melt rheology for certain melt processes, such as blown film and extrusion coatings, and reduced moisture absorption in the enduse article.

Importantly, the ionomer compositions combine the properties of being self-dispersible in hot water along with being thermoplastic, allowing for fabrication into many articles of commerce. The ionomer compositions may be coated onto substrates as either aqueous dispersions or as molten compositions, allowing great flexibility in manufacture of coated articles. Preferably, the ionomers used herein have a melt flow rate (MFR) of at least 1 gram/10 min, such as about 1 to about 20 grams/10 min as measured by ASTM D1238 at 190° C. using a 2160 g load. More preferably, the ionomer composition has a MFR of about 1 to about 10 grams/10 min, and most preferably has a MFR of about 1 to about 5 grams/10 min. The combination of the above described parent acid copolymer melt flow rates and the neutralization levels provides ionomers which combine the properties of being easily self-dispersible in hot water and easily melt fabricated into articles of commerce.

Preferably, the ionomer composition comprises at least 11 weight ° A) methacrylic acid salt and has a MFR of at least 1 g/10 min.

In some embodiments, blends of two or more ionomers may be used, provided that the aggregate components and properties of the blend fall within the limits described above for the ionomers.

The ionomer composition may also contain other additives known in the art. The additives may include, but are not limited to, processing aids, flow enhancing additives, lubricants, pigments, dyes, flame retardants, impact modifiers, nucleating agents, anti-blocking agents such as silica, thermal stabilizers, UV absorbers, UV stabilizers, surfactants, chelating agents, and coupling agents.

Dispersion Method

The invention provides a method to form an aqueous comprising an ionomer, the method comprising or consisting essentially of

(a) providing a solid ionomer composition as described above;

(b) mixing the solid ionomer composition with water heated to a temperature from about 85 to about 100° C. (preferably under low shear conditions) to provide a heated aqueous ionomer dispersion; and

(c) optionally cooling the heated aqueous ionomer dispersion to a temperature of about 20 to about 30° C., wherein the ionomer remains dispersed in the liquid phase;

The dispersion method step (b) described herein surprisingly allows for the production of aqueous ionomer composition dispersions under very mild process conditions, such as low shear to provide at least sufficient mixing to maintain good contact of large particles of solid ionomer with the water (e.g. simply stirring a mixture of hot water and solid ionomer) and low temperature (less than the boiling point of water) at atmospheric pressure, requiring less energy than prior art dispersion processes. This dispersion method also provides an inherently safer dispersion process through the use of preformed ionomer compositions by allowing for the avoidance of strong bases, such aqueous sodium hydroxide (caustic) and/or ammonia, during the dispersion process.

The dispersion method comprises contacting the ionomer composition with water at a temperature from about 85 to about 100° C. In some embodiments, the temperature is in the range from about 85 to about 95° C., while in other embodiments, the temperature is preferably about 90° C. However, one can appreciate that if the ionomers disperse in that temperature range they can also be dispersed at temperatures above 100° C.

Articles comprising the ionomer composition article may take any physical form desired, such as powder, pellets, melt cut pellets, coatings, films, sheets, molded articles and the like. The ionomer dispersion may be produced in any suitable vessel, such as a tank, vat, pail and the like. Stirring is useful to provide effective contact of the bulk ionomer article(s) with water. One can also appreciate that high shear conditions may also be used, but are not necessary. Preferably the dispersion is produced in about 1 hour or less, such as in about 30 minutes or in about 20 minutes or less. Due to the surprisingly rapid dispersibility of the articles comprising the ionomer compositions, it is further contemplated that the process may proceed within a pipeline in which the components of the dispersion are charged at one end of the pipeline and form the dispersion as they proceed down the length of the pipeline. For example, the article may be mixed with water and passed through a heated zone, with or without added mixing, such as through static mixers. Alternatively, the article may be mixed with hot water and passed through a pipeline, with or without added mixing, such as through static mixers.

In one embodiment, the article comprising the ionomer composition is mixed with water under low shear conditions at room temperature (about 20 to 25° C.) and the temperature is raised to about 85 to about 100° C. In another embodiment, the article comprising the ionomer composition is mixed with water under low shear conditions at room temperature and the temperature is raised to about 85 to about 95° C.

In another embodiment, the article comprising the ionomer composition is mixed with water preheated to a temperature of about 85 to about 100° C. under low shear conditions. In another embodiment, the article comprising the ionomer composition is mixed with water preheated to a temperature of about 85 to about 95° C. under low shear conditions.

The aqueous ionomer coating dispersion preferably comprises from a lower limit of about 0.001 or about 1 weight % to an upper limit of about 10, about 20, about 30 or about 50 weight %, such as from about 1 to about 20 weight %, of the ionomer composition based on the total weight of the ionomer composition and the water.

The ionomer dispersion composition may include other additives known in the art. For example, the compositions may include a wax additive, such as a microcrystalline wax or a polyethylene wax, which serves as an anti-blocking agent as well as to improve the coefficient of friction of the final coated substrate. Other types of additives include fumed silica, which reduces the tack of the coating at room temperature, calcium carbonate, talc, cross-linking agents, anti-static agents, defoamers, dyes, brighteners, fillers processing aids, flow enhancing additives, lubricants, dyes, pigments, flame retardants, impact modifiers, nucleating agents, anti-blocking agents, thermal stabilizers, UV absorbers, UV stabilizers, surfactants, chelating agents, and coupling agents and the like.

### Substrate Materials

The substrate may be any material providing support, shape, esthetic effect, protection, surface texture, bulk volume, weight, or combinations of two or more thereof to enhance the functionality and handability of the structure. Essentially any substrate material known in the art may be used.

Any support or substrate meeting these desired characteristics may be used with the self-dispersible ionomer composition. Cellulosic materials such as paper webs (for example kraft or rice paper), materials made from synthetic fiber spun fabrics, films, open-cell foams, closed-cell foams, microporous films, or even perforated films having large percentages of open areas such as perforated PE films, may be used as materials for the substrate(s), for example. Metallic foils such as aluminum foil may also be used as substrates.

Cellulosic materials include paper, paperboard, cardboard, and pulp-molded shapes. Paper, paperboard, cardboard and the like refer to physical forms derived from cellulose or its derivatives that have been processed as a pulp and formed by heat and/or pressure into sheets. Paper describes thin sheets made from cellulose pulp that are somewhat flexible or semi-rigid. In general, paperboard and cardboard are thicker, rigid sheets or structures based on paper. Typically, paperboard is defined as a paper with a basis weight above 224 g/m². In accordance with the present disclosure, the paper layer or paperboard layer used in the substrate may have a thickness of about 30 to 600 μm and a basis weight of about 25 to 500 g/m², or 100 to 300 g/m². Cardboard can be a monolithic sheet or can have a more complex structure, such as corrugation. Corrugated cardboard comprises a sheet of corrugated paper adhesively sandwiched between two flat sheets of paper. Pulp-molded shapes are typically nonplanar shapes in which the cellulosic pulp is molded into a rigid shape by application of pressure and/or heat. An example pulp-molded shape is an egg carton.

Example substrates also include a textile or porous sheet material. A textile may also include nonwoven textiles prepared from polypropylene, polyethylene, polyesters such as polyethylene terephthalate or mixtures thereof, and other spun bonded polymer fabrics. Sheets made from synthetic fiber spun fabrics, such as nonwoven textiles, may be used as a textile substrate. Cloth that is woven, knitted or the like is also suitable as a textile substrate. Natural fibers alone or in combination with man-made fibers can also be used in textile substrates. A fabric may comprise flame retardant(s), filler(s), or additive(s) disclosed above.

The substrate material may be in the form of a film, sheet, woven fabric, nonwoven fabric and the like. The substrate material may be unoriented or oriented, such monoaxially- or biaxially-oriented. The substrate material may comprise a polymeric or a metal composition. The substrate may be treated to enhance, for example, adhesion with the coating. The treatment may take any form known in the art such as for example, adhesive, primer or coupling agent treatments or surface treatments, such as chlorine treatments, flame treatments (see, e.g., U.S. Pat. Nos. 2,632,921; 2,648,097; 2,683,894; and 2,704,382), plasma treatments (see e.g., U.S. Pat. No. 4,732,814), electron beam treatments, oxidation treatments, chemical treatments, chromic acid treatments, hot air treatments, ozone treatments, ultraviolet light treatments, sand blast treatments, solvent treatments or corona treatments and combinations of the above.

Specific examples of substrate materials include poly(ethylene terephthalate) (PET) films, biaxially-oriented poly(propylene) (BOPP) films, polyamide films, aluminum foil, paper, paperboard, and the like. Preferably, the substrate material is paper, paperboard and the like to allow for repulpability after use.

The substrate material may be any thickness, but generally range from about 0.1 to about 20 mils thick, more generally from about 0.5 to about 10 mils thick.

### Dispersion Coating Method

The invention provides a method to form a coating comprising an ionomer on a substrate, the method comprising or consisting essentially of

(a) providing a solid ionomer composition as described above;

(b) mixing the solid ionomer composition with water at a temperature from about 85 to about 100° C. (preferably under low shear conditions) to provide a heated aqueous ionomer dispersion;

(c) optionally cooling the heated aqueous ionomer dispersion to a temperature of about 20 to about 30° C., wherein the ionomer remains dispersed in the liquid phase;

(d) coating the aqueous ionomer dispersion onto a substrate; and

(e) drying the coated substrate at a temperature of about 20 to about 150° C.

The dispersion method step (b) described herein surprisingly allows for the production of aqueous ionomer composition dispersions under very mild process conditions, such as low shear to provide at least sufficient mixing to maintain good contact of large particles of solid ionomer with the water (e.g. simply stirring a mixture of hot water and solid ionomer) and low temperature (less than the boiling point of water) at atmospheric pressure, requiring less energy than prior art dispersion processes. This step is essentially the dispersion method described above, which provides an inherently safer dispersion process through the use of preformed ionomer compositions by allowing for the avoidance of strong bases, such as aqueous sodium hydroxide (caustic) and/or ammonia, during the dispersion process.

In one embodiment, the article comprising the ionomer composition is mixed with water under low shear conditions at room temperature (about 20 to 25° C.) and the temperature is raised to about 85 to about 100° C. In another embodiment, the article comprising the ionomer composition is mixed with water under low shear conditions at room temperature and the temperature is raised to about 85 to about 95° C.

In another embodiment, the article comprising the ionomer composition is mixed with water preheated to a temperature of about 85 to about 100° C. under low shear conditions. In another embodiment, the article comprising the ionomer composition is mixed with water preheated to a temperature of about 85 to about 95° C. under low shear conditions.

The aqueous ionomer coating dispersion preferably comprises from a lower limit of about 0.001 or about 1 weight % to an upper limit of about 10, about 20, about 30 or about 50 weight %, such as from about 1 to about 20 weight %, of the ionomer composition based on the total weight of the ionomer composition and the water.

The ionomer dispersion coating composition may include other additives known in the art. For example, the compositions may include a wax additive, such as a microcrystalline wax or a polyethylene wax, which serves as an anti-blocking agent as well as to improve the coefficient of friction of the final coated substrate. Other types of additives include fumed silica, which reduces the tack of the coating at room temperature, calcium carbonate, talc, cross-linking agents, anti-static agents, defoamers, dyes, brighteners, fillers processing aids, flow enhancing additives, lubricants, dyes, pigments, flame retardants, impact modifiers, nucleating agents, anti-blocking agents, thermal stabilizers, UV absorbers, UV stabilizers, surfactants, chelating agents, and coupling agents and the like.

Once prepared, the ionomer composition is coated onto a substrate as described below.

In some embodiments the ionomer composition can be coated directly on a substrate using impregnation and coating techniques. For example, the ionomer composition is a coating applied directly on the substrate (via extrusion coating, spraying, painting or other appropriate application methods). Such coating can be applied using spreading methods known in the art such as with a rubber doctor blade or with a slit extrusion machine.

The composition can be applied to one side or both sides of a substrate. In the case where the substrate is coated or laminated on one side, the composition may be applied to the side that is directly exposed to the environment to provide a liquid-impermeable outer surface. Alternatively, in applications where mechanical wear or abrasion is likely, the composition may be applied to the side of the substrate opposite the side exposed to the mechanical wear to afford protection of the polymeric composition.

In other embodiments the composition can be impregnated in a substrate or the substrate can be impregnated in the polymer.

The ionomer composition may be formed at least partially in the substrate by impregnating the substrate with the ionomer as an aqueous dispersion or by applying the molten composition to the substrate and then cooling the composition while it is in contact with the pores of the substrate.

The composition can be dispersed throughout the substrate such as a loosely woven fabric where the composition fills gaps in the substrate and does not just adhere on the surface of a substrate. The substrate can be impregnated inside the ionomer composition through lamination or coextrusion process to have the ionomer compositions on both sides of the substrate.

The coating as an aqueous dispersion can be applied to the substrate in any suitable manner known in the art, including gravure coating, roll coating, wire rod coating, dip coating, flexographic printing, spray coating and the like. Excess aqueous dispersion coating composition can be removed by squeeze rolls, doctor knives and the like, if desired.

For the preferred paper and paperboard substrates, the substrates may be applied to the preformed paper or paperboard substrate, as described above, or during the manufacture of the paper or paperboard substrates using, for example, size presses, such as a puddle size press, a metering size press, a vertical size press, and a horizontal size press, roll coaters, gate-roll coaters, blade coaters, bill blade coaters, and sprayers to coat the coating composition onto the paper or paperboard substrate.

The coating composition can be applied to one or both sides of the substrate.

After coating the substrate, the aqueous dispersion is dried to provide a solid coating of ionomer on the substrate. As used herein, “drying” means removal of water from the aqueous dispersion, such as by evaporation, freeze drying, or the like. Drying may include allowing the dispersion to dry under ambient conditions (temperatures of 20 to 30° C. and atmospheric pressure). Alternatively, drying may include application of elevated temperatures (such as up to 100° C. in an oven or heating tunnel) and/or reduced pressure. Freeze drying involves rapid freezing and drying in a high vacuum.

### Non-Dispersion Coating Methods

These non-dispersion coating methods take advantage of the excellent thermoplastic properties of the ionomer composition. After preparation, the coated substrates can then take advantage of the ready dispersibility of the ionomer composition in water, for example to allow for recyclability.

Accordingly, the invention provides a method to form a coating comprising an ionomer on a substrate, the method comprising or consisting essentially of

(a) providing a solid ionomer composition as described above;

(b) melting the solid ionomer composition at a temperature from about 80 to about 300° C. to provide a molten, flowable ionomer composition;

(c) coating the molten ionomer composition onto a substrate; and

(d) cooling the coated substrate to a temperature of about 20 to about 30° C.

The ionomer composition can be extrusion-coated onto the substrate by any known art method. For example, pellets of the ionomer composition can be fed through a single screw or twin screw extruder to provide a molten ionomer composition. The molten composition is fed through a slot die to provide a curtain of molten ionomer which contacts the substrate as it passes below. The substrate coated with molten ionomer can be passed through a nip and/or over chill roll(s) to cool the molten ionomer coating. The coated substrate may be collected on winder rolls for future use or can be further manipulated to provide finished articles.

Additionally, the ionomer coating layer can be coextrusion coated with one or more layers of additional thermoplastic material(s) to provide a multilayer coating. In such coextrusion processes, the ionomer coating layer may be applied so it is in direct contact with the substrate, or it may be applied so it is in contact with a layer intervening between the substrate and the ionomer layer.

The ionomer composition can be applied to one or both sides of the substrate. Preferably, the ionomer composition layer has a thickness from about 0.1 mils to about 20 mils, more preferably a thickness from about 0.3 mils to about 10 mils and most preferably a thickness from about 0.5 mils to about 5 mils.

Alternatively, the invention provides a method to form a coating comprising an ionomer on a substrate, the method comprising or consisting essentially of, the method comprising or consisting essentially of

(a) providing a preformed film of an ionomer composition as described above;

(b) producing a prelaminate structure comprising the ionomer film layer adjacent to a substrate layer;

(c) laminating the ionomer film layer to the substrate layer at a temperature from about 50 to about 150° C. and optionally with applied pressure;

(d) cooling the coated substrate to a temperature of about 20 to about 30° C.

The preformed film of the ionomer composition may be produced by any known art method. For example, thin films can be formed by dipcoating; by compression molding; by melt extrusion; by melt blowing; or any other processes known to those skilled in the art. Films of the ionomer composition are preferably formed by extrusion methods, including, for example, extrusion casting and blown film processes.

In the film lamination method, the ionomer coating layer can be included in a multilayer structure with one or more layers of additional material(s) to provide a multilayer coating. In such processes, the ionomer coating layer may be applied so it is in direct contact with the substrate, or it may be applied so it is in contact with a layer intervening between the substrate and the ionomer layer.

The actual making of the film, multilayer film, and corresponding film structures can generally be by any such method as practiced in the art. As such, the film and film structures can be typically cast, extruded, co-extruded and the like including orientation (either axially or biaxially) by various methodologies (e.g., blown film, bubble techniques, mechanical stretching or the like, or lamination). It should be appreciated that various additives as generally practiced in the art can be present in the respective film layers including the presence of tie layers and the like, provided their presence does not substantially alter the properties of the film or film structure. Thus, it is contemplated that various additives such as antioxidants and thermal stabilizers, ultraviolet (UV) light stabilizers, pigments and dyes, fillers, anti-slip agents, plasticizers, other processing aids, and the like may be advantageously employed.

The preformed film of the ionomer composition can be applied to one or both sides of the substrate. Preferably, the ionomer composition layer has a thickness from about 0.1 mils to about 20 mils, more preferably a thickness from about 0.3 mils to about 10 mils and most preferably a thickness from about 0.5 mils to about 5 mils.

The laminate structures may be produced by any known art method. For example, the prelaminate structure can be produced by plying the preformed film of the ionomer composition with the substrate followed by passing through heated nip rolls or through an oven to form the laminate.

In these non-dispersion coating methods, after coating the substrate, the coated substrate is cooled to provide a solid ionomer coating on the substrate. As used herein, “cooling” includes allowing the molten ionomer coating to cool under ambient conditions (temperatures of 20 to 30° C. and atmospheric pressure) or by application of reduced temperatures such as by use of chill rolls or the like.

Additional non-ionomeric layers may be applied to the ionomer-coated substrate following coating. For example, additional aqueous or solvent-based dispersions not comprising an ionomer may be applied to the coated substrate. Alternatively, multilayer structures may comprise additional thermoplastic materials applied over the ionomer layer by extrusion coating, lamination or the like. In such cases, the ionomer becomes an inner layer in a multilayer structure.

The ionomer coating composition can also be accommodated between two layers of substrate in a sandwich-like manner. Several layer assemblies can also be assembled one above the other. For example, the configuration can comprise the ionomer layer, a substrate layer, another ionomer layer, another substrate layer, and so on, depending upon desired applications of the structure. Other configurations can comprise variations of the aforementioned sandwich configuration, including a plurality of ionomer layers, a plurality of substrate layers, and so forth, including mixtures thereof.

In such cases, in aqueous dispersion coating methods the ionomer coating may be maintained in an aqueous state during assembly of the layered structure, followed by drying. Alternatively, in extrusion coating methods the ionomer coating may be maintained in a molten state during assembly of the layered structure, followed by cooling. In the resulting layered structures, the ionomer coating may function as an adhesive layer to bond substrate layers together.

The coated substrates described herein may be used as film or sheet goods for various end uses. Alternatively, the initially prepared coated substrate may be further treated to provide more finished articles.

For example, the coated substrate may be part of a package comprising the coated substrate. The packages may comprise films or sheets of the coated substrate wrapped around the packaged product and optionally comprising other packaging materials. Packages may also be formed of one or more portions of the coated substrate bonded together, for example by heat sealing. The ionomer coating is readily heat sealable, allowing for production of packages comprising a coated paper substrate that does not need additional adhesive for sealing. Such packages or containers may be in the form of pouches, bags, boxes, cartons, cups, packets, and the like.

A film or sheet comprising the coated substrate could be further processed by thermoforming into a shaped article. For example, a film or sheet comprising the coated substrate as described herein could be formed into a shaped piece that could be included in packaging. Thermoformed articles typically have a shape in which a sheet of material forms a concave surface such as a tray, cup, can, bucket, tub, box or bowl. The thermoformed article may also comprise a film or sheet with a cup-like depression formed therein. In some cases, the thermoformed film or sheet is shaped to match the shape of the material to be packaged therein. Flexible films when thermoformed as described retain some flexibility in the resulting shaped article. Thicker thermoformed sheets may provide semi-rigid or rigid articles. Thermoformed articles may be combined with additional elements, such as a generally planar film that serves as a lid sealed to the thermoformed article.

Preferably, the container is suitable for containing, transporting or storing food that may contain grease or oil, including snack foods such as chips, crackers, cookies, cereal or nuts; dry noodles, soup mix, coffee, French fries, sandwiches, pet foods and the like. Frozen or chilled foods such as ice cream, vegetables, waffles and the like may also be packaged in packages comprising the coated substrate. Non-food items such as detergents and soaps may also be packaged in packages comprising the coated substrate. Products for serving foods may also be prepared from the coated substrate such as cold drink cups, plates, bowls and the like.

Pouches are formed from coated web stock by cutting and heat sealing separate pieces of coated web stock and/or by a combination of folding and heat sealing with cutting. Coated substrates may be formed into pouches by overlaying and heat sealing the edges of the substrate to form a seal and then sealing across the lengthwise direction of the tube (transverse seal). Other packages include containers, optionally further comprising lidding films such as cups or tubs prepared from coated substrates as described herein and flexible packages made by laminating the coated substrate to another webstock to improve characteristics such as stiffness and appearance.

Preferred packages comprise one or more of the preferred or notable or structures as described herein. Preferred packaged products comprise one or more of the preferred or notable films or structures as described herein.

Once used for its intended purpose such as for packaging or serving food, the coated substrate is easily recyclable by treatment with hot water. The ionomer coating is readily dispersed in hot water, allowing it to be removed from the substrate.

The process for separating the ionomer coating from the substrate materials comprised in containers disclosed herein may include contacting the container with water at a temperature as low as about 85° C. In some embodiments, the temperature is in the range from about 85-100° C., or about 85-95° C., or about 90° C. However, one can appreciate that if the water-dispersible ionomer compositions can disperse in such temperatures, they can also be dispersed at temperatures above 100° C. Also, in some embodiments, the container may be cut into pieces before being contacted with water.

In normal circumstances, the water-dispersible ionomer compositions could be dispersed in warm water in about 1 hour or less, such as in about 30 minutes or less or in about 20 minutes or less. Once the water-dispersible ionomer composition is fully dispersed in the water, the substrate materials can be separated from the aqueous ionomer dispersion. Then the non-ionomer materials comprised in the container, such as paperboard base material or aluminum foil, could then be separated from the aqueous phase by, for example filtration, for recycling. In some cases, it may not be necessary to separate completely dispersed ionomer from paper pulp. The fiber can be reused because recycled paper typically contains some small fraction of dispersed “plastic”, waxes, hot melt components, etc., and minimal amounts can be tolerated if the particle size is small.

In one embodiment, to remove the coating from the substrate materials, the container (preferably after use) disclosed herein is first mixed with water under low shear conditions at room temperature (about 20 to 25° C.) and then the temperature or the mixture is raised to about 85 to 100° C.

In a further embodiment, to remove the coating from the substrate materials, the container (preferably after use) disclosed herein is mixed with water under low shear conditions at room temperature and then the temperature of the mixture is raised to about 85 to 95° C.

In a yet further embodiment, to remove the coating from the substrate materials, the container (preferably after use) disclosed herein is mixed with water that is preheated to a temperature of about 85 to 100° C. under low shear conditions.

In a yet further embodiment, to remove the coating from the substrate materials, the container (preferably after use) disclosed herein is mixed with water that is preheated to a temperature of about 85 to 95° C. under low shear conditions.

The substrate materials can be collected and recycled into new articles. For example, paper and paperboard materials can be repulped by methods known in the art and processed into new articles.

The aqueous ionomer dispersion can also be further processed to recover the ionomer. For example, excess water can be removed by distillation, evaporation, freeze drying, or the like to provide the ionomer in solid form. Alternatively, the ionomer can be purified from other water-soluble materials by subjecting the aqueous dispersion to acid treatment, providing the base ethylene acid copolymer that is insoluble in water. The solid acid copolymer can be re-neutralized according to methods disclosed herein to provide the ionomer.

### EXAMPLES

### Examples 1 to 3 and Comparative Examples C1 to C3

The ionomers summarized below in Table 1 were prepared from the poly(ethylene-co-methacrylic acid) dipolymer denoted as C1 with a methacrylic acid level of 19 weight % and a melt flow rate (MFR) of 300 g/10 minutes. Ionomers were prepared from this acid copolymer using standard conditions with the indicated percentage of the carboxylic acid groups neutralized with sodium hydroxide to form sodium salts and/or zinc oxide to form zinc salts. Melt flow rate (MFR) was measured according to ASTM D1238 at 190° C. using a 2160 g load. A similar ISO test is ISO 1133. Moisture was determined with an Arizona Instrument Computrac Vapor Pro ZSP 150 with a top plate balance and dessicant tower.

The water dispersibility was determined according to the following General Procedure. The General Procedure illustrates addition of the non-neutralized acid copolymer or ionomer to water followed by heating.

The procedure produced a mixture of water and 10 weight % solid loading (as weighed prior to addition to the water). Into a 1 quart (946.4 mL) metal can placed into a heating mantle element was added 500 mL of distilled water and the non-neutralized acid copolymer resin C1 or the ionomer (55.5 grams, in the form of melt cut pellets) indicated in Table 1. An overhead paddle stirrer (3-paddle propeller type stirrer) was positioned into the center of the metal can and turned on to provide slow mixing. A thermocouple was positioned below the water surface between the paddle stirrer and the metal can surface. The paddle stirrer was typically set at a speed of about 170 rpm at the beginning of the process and generally raised to about 300 to 470 rpm as the viscosity built during dispersion formation. The distilled water was then heated with an Omega temperature controller to a temperature of 90° C. The resulting mixture was stirred for a total of 20 minutes. The resulting mixture was then allowed to cool to room temperature.

Materials that did not form dispersions at the temperature indicated are denoted as “No” in Table 1, below. For those materials that formed a dispersion (denoted as “Yes” in Table 1, below), the dispersion was generally formed in less than 10 minutes and was stable even after being cooled to room temperature. As used herein, “stable” means that the dispersion, a liquid with no visible solids, did not exhibit any visual change after the initial cooling or on storage at room temperature. The Example dispersions remained as liquids with no settling after storing at room temperature for periods of several weeks or longer.

TABLE 1

| | Na Ion | | | Water | |
|---|---|---|---|---|---|
| | Level | Zn Ion | MFR | Dispersibility | Moisture |
| Example | (%) | Level (%) | (g/10 min) | at 90° C. | (ppm) |
| C1 | 0 | 0 | 300 | No | |
| C2 | 60 | 0 | 2.3 | Yes | 975 |
| 1 | 59 | 1 | 2.2 | Yes | 544 |
| 2 | 57.5 | 2.5 | 2.3 | Yes | 752 |
| 3 | 55 | 5 | 2.2 | Yes | 336 |
| C3 | 50 | 10 | 1.6 | No | 179 |

### Example 4

The procedure produced a mixture of water and 10 weight % solid loading (as weighed prior to addition to the water). Into a 1 quart (946.4 mL) metal can placed into a heating mantle element was added 500 mL of distilled water. An overhead paddle stirrer (3-paddle propeller type stirrer) was positioned into the center of the metal can and turned on to provide slow mixing. A thermocouple was positioned below the water surface between the paddle stirrer and the metal can surface. The paddle stirrer was typically set at a speed of about 170 rpm at the beginning of the process and generally raised to about 300 to 470 rpm as the viscosity built during dispersion formation. The distilled water was then heated with an Omega temperature controller to a temperature of 90° C. The ionomer used in Example 1 (55.5 grams, in the form of melt cut pellets) indicated in Table 1 was then added in one portion and the resulting mixture was stirred for a total of 20 minutes. The resulting mixture was then allowed to cool to room temperature. A dispersion was formed within 12 minutes after the addition of ionomer which was stable and remained in the dispersion form after cooling.

1. An ionomer composition comprising a parent acid copolymer that consists of copolymerized units of ethylene and 18 to 30 weight % of copolymerized units of acrylic acid or methacrylic acid, based on the total weight of the parent acid copolymer, the parent acid copolymer having a melt flow rate (MFR) from 200 to 1000 g/10 min., wherein 50% to 70% of the carboxylic acid groups of the copolymer, based on the total carboxylic acid content of the parent acid copolymer as calculated for the non-neutralized parent acid copolymer, are neutralized to carboxylic acid salts consisting of 90 to 99%, based on the total of neutralized carboxylic acid salts, monovalent alkali metal cations selected from the group consisting of sodium cations, potassium cations, lithium cations or mixtures thereof and 10 to 1%, based on the total of neutralized carboxylic acid salts, of zinc cations and wherein the ionomer composition has a MFR from 1 to 20 g/10 min., each MFR measured according to ASTM D1238 at 190° C. with a 2160 g load.

2. The ionomer composition of claim 1 wherein the carboxylic acid salts comprise 91.5 to 99%, based on the total of neutralized carboxylic acid salts, of sodium cations, potassium cations, lithium cations or mixtures thereof and 8.5 to 1%, based on the total of neutralized carboxylic acid salts, of zinc cations.

3. The ionomer composition of claim 1 wherein the parent acid copolymer consists of ethylene and about 19 to about 25 weight % of the alpha, beta-ethylenically unsaturated carboxylic acid, based on the total weight of the copolymer.

4. The ionomer composition of claim 1 wherein the parent acid copolymer consists of ethylene and about 19 to about 23 weight % of the alpha, beta-ethylenically unsaturated carboxylic acid, based on the total weight of the copolymer.

5. The ionomer composition of claim 1 wherein the alpha, beta-ethylenically unsaturated carboxylic acid is methacrylic acid.

6. The ionomer composition of claim 1 wherein the monovalent alkali metal cations are sodium cations.

7. A method to form an aqueous dispersion comprising an ionomer comprising
(a) providing a solid ionomer composition according to claim 1;
(b) mixing the solid ionomer composition with water heated to a temperature from 85 to 100° C. to provide a heated aqueous ionomer dispersion wherein the ionomer composition comprises 0.001 to 50 weight % of the aqueous ionomer dispersion;
(c) optionally cooling the heated aqueous ionomer dispersion to a temperature of 20 to 30° C., wherein the ionomer remains dispersed in the liquid phase.

8. The method of claim 7 wherein (b) comprises (i) adding an article formed from the preformed solid ionomer composition to water at a temperature of 20 to 30° C. to form a mixture of solid ionomer and water; and subsequently (ii) heating the mixture to a temperature from 85 to 100° C.

9. The method of claim 7 wherein (b) comprises adding an article formed from the preformed solid ionomer composition to water preheated to a temperature from 85 to 100° C.

10. The method of claim 7 wherein the carboxylic acid salts consist of 91.5 to 99%, based on the total of neutralized carboxylic acid salts, of sodium cations, potassium cations, lithium cations or mixtures thereof and 8.5 to 1%, based on the total of neutralized carboxylic acid salts, of zinc cations.

11. The method of claim 7 wherein the parent acid copolymer consists of ethylene and about 19 to about 25 weight % of the alpha, beta-ethylenically unsaturated carboxylic acid, based on the total weight of the copolymer.

12. The method of claim 7 wherein the parent acid copolymer consists of ethylene and about 19 to about 23 weight % of the alpha, beta-ethylenically unsaturated carboxylic acid, based on the total weight of the copolymer.

13. The method of claim 7 wherein the alpha, beta-ethylenically unsaturated carboxylic acid is methacrylic acid.

14. The method of claim 7 wherein the monovalent alkali metal cations are sodium cations.

15. A coated substrate comprising an ionomer layer on a substrate wherein
(a) the substrate comprises paper, paperboard, cardboard, pulp-molded shape, textile, material made from a synthetic fiber spun fabric, film, open-cell foam, closed-cell foam, or metallic foil; and
(b) the ionomer layer comprises an ionomer composition according to claim 1.

16. A method to prepare a coated substrate comprising an ionomer layer on a substrate, the method comprising (a) providing an ionomer composition comprising the ionomer according to claim 1; (b) providing a substrate; and (c) applying the ionomer composition to the substrate.

17. The method of claim 16 wherein the substrate comprises paper, paperboard, cardboard, pulp-molded shape, textile, material made from a synthetic fiber spun fabric, film, open-cell foam, closed-cell foam, or metallic foil.

18. The method of claim 16 wherein the ionomer composition is in the form of an aqueous ionomer dispersion wherein the aqueous ionomer dispersion is prepared by
(1) providing a solid ionomer composition comprising a parent acid copolymer that consists of copolymerized units of ethylene and 18 to 30 weight % of copolymerized units of acrylic acid or methacrylic acid, based on the total weight of the parent acid copolymer, the parent acid copolymer having a melt flow rate (MFR) from 200 to 1000 g/10 min., wherein 50% to 70% of the carboxylic acid groups of the copolymer, based on the total carboxylic acid content of the parent acid copolymer as calculated for the non-neutralized parent acid copolymer, are neutralized to carboxylic acid salts comprising 90 to 99%, based on the total of neutralized carboxylic acid salts, monovalent alkali metal cations selected from the group consisting of sodium cations, potassium cations, lithium cations and mixtures thereof and 10 to 1%, based on the total of neutralized carboxylic acid salts, of zinc cations and wherein the ionomer composition has a MFR from 1 to 20 g/10 min., each MFR measured according to ASTM D1238 at 190° C. with a 2160 g load;
(2) mixing the solid ionomer composition with water heated to a temperature from 85 to 100° C. to provide a heated aqueous ionomer dispersion wherein the ionomer composition comprises 0.001 to 50 weight % of the aqueous ionomer dispersion;
(3) optionally cooling the heated aqueous ionomer dispersion to a temperature of 20 to 30° C., wherein the ionomer remains dispersed in the liquid phase; and wherein
(c) comprises (1) coating the aqueous ionomer dispersion onto the substrate; and
(2) drying the coated substrate at a temperature of 20 to 150° C.

19. The method of claim 18 wherein (a)(2) comprises (i) adding the solid ionomer composition to water at a temperature of 20 to 30° C. to form a mixture of solid ionomer and water; and subsequently (ii) heating the mixture to a temperature from 85 to 100° C.

20. The method of claim 18 wherein (a)(2) comprises adding the solid ionomer composition to water preheated to a temperature from 85 to 100° C.

21. The method of claim 18 comprising
(a)(1) providing a solid ionomer composition according to claim 1;
(a)(2) melting the solid ionomer composition at a temperature from 80 to 300° C. to provide a molten, flowable ionomer composition;
(b) providing the substrate;
(c)(1) coating the molten ionomer composition onto the substrate; and
(c)(2) cooling the coated substrate to a temperature of 20 to 30° C.

22. The method of claim 18 comprising
(a) providing a solid ionomer composition according to claim 1;
(b) providing a substrate;
(c)(1) producing a prelaminate structure comprising a layer of the ionomer film layer adjacent to the substrate;
(2) laminating the ionomer film layer to the substrate layer at a temperature from 50 to 150° C. and optionally with applied pressure;
(3) cooling the coated substrate to a temperature of 20 to 30° C.
